(19) United States
(12) Patent Application Publication
(10) Pub. No.: US 2006/0073284 A1
(43) Pub. Date: Apr. 6, 2006

(54) Applied film forming apparatus and applied film forming method

(75) Inventors: Mamoru Usami, Tokyo (JP); Takeshi Umega, Tokyo (JP); Tomoki Ushida, Tokyo (JP); Seiichi Idezawa, Tokyo (JP); Yoshimi Yodogawa, Tokyo (JP); Yukio Kaneko, Tokyo (JP)

Correspondence Address: GREENBLUM & BERNSTEIN, P.L.C., 1950 ROLAND CLARKE PLACE, RESTON, VA, 20191, US

(73) Assignee: TDK Corporation, Tokyo (JP)

(21) Appl. No.: 11/237,831

(22) Filed: Sep. 29, 2005

(30) Foreign Application Priority Data
Oct. 1, 2004 (JP) 2004-290789

(51) Int. Cl. G11B 7/26; B05C 9/08; C08F 2/46

(52) U.S. Cl. 427/508; 427/487; 118/52; 118/668; 118/620

(57) ABSTRACT

An applied film forming apparatus that forms an applied film on one surface of a substrate includes a dripping unit that drips an energy beam-curing applied material onto the one surface of the substrate, a rotating unit that rotates the substrate, a curing processing unit that emits an energy beam onto the applied material to cure the applied material, an emission regulating unit that regulates emission of the energy beam onto the applied material on an outer circumferential edge part of the one surface of the substrate, and a control unit. After controlling the dripping unit to drip the applied material onto the one surface and controlling the rotating unit to rotate the substrate and spread the applied material, the control unit controls the rotating unit to rotate the substrate at a predetermined rotational velocity, controls the curing processing unit to emit the energy beam toward the one surface, and additionally controls the emission regulating unit to regulate the emission of the energy beam onto the applied material on the outer circumferential edge part of the one surface of the substrate.

### BACKGROUND OF THE INVENTION

1. Field of the Invention

The present invention relates to an applied film forming apparatus and applied film forming method that form an applied film by spreading an applied film forming material on one surface of a substrate.

2. Description of the Related Art

Spin coating is conventionally known as a method of forming an applied film on one surface of a substrate used for an information recording medium. During spin coating, an applied material is dripped onto one surface of the substrate and the substrate is then rotated at high speed to spread out the applied material using centrifugal force. Accordingly, by carrying out spin coating, it is possible to form an applied film with a comparatively uniform thickness. On the other hand, when an applied material is spread out by spin coating, since the applied material protrudes beyond an outer circumferential edge part of the substrate due to centrifugal force, when the rotational velocity of the substrate falls at the end of spin coating, the protruding applied material is pulled back toward the outer circumferential edge part by the surface tension of the applied material itself, resulting in an upward convex part being formed at the outer circumferential edge part. In the case, for example, of an information recording medium where the thickness of the applied film on a side of the substrate on which a laser beam for recording (or reading) data is incident is set at around 100 μm and the distance (working distance) between an optical pickup of a drive apparatus and the applied film during driving is set at around 1001 μm, if the convex part is large, there is the risk of problems occurring due to the optical pickup of the drive apparatus contacting the convex part. As one technology for solving the above problem, Japanese Laid-Open Patent Publication No. H11-86355 discloses a manufacturing method that manufactures an optical disc (an information recording medium) by removing the convex part in a trimming process. In this manufacturing method, a UV-curing resin (hereinafter, referred to simply as “resin”) is applied to a substrate by spin coating. After this, UV rays are emitted to cure the applied resin. By doing so, a disc that has a light-transmitting layer formed on a signal surface of the substrate is completed. In this case, a convex part (a built-up part) made of resin is formed as described above at the outer circumferential edge part of the disc in this state. Next, the trimming process is carried out. More specifically, a trimming tool is pressed onto the outer circumferential edge part of the disc while the disc is being rotated. When doing so, the outer circumferential edge part (i.e., the cured resin) of the disc is cut away by the tool, thereby removing the convex part formed at the outer circumferential edge part of the disc.

By investigating the manufacturing method described above, the present inventors discovered the following problem. That is, in the above manufacturing method, after the resin applied onto the substrate has been cured, a trimming process that cuts away the resin using a tool is carried out. In this case, when the cured resin is cut away, the resin is pulverized and scattered, and may adhere to the disc. Accordingly, this manufacturing method has a problem in that errors may occur during use of the disc (optical disc) due to pulverized resin adhering to the disc. Here, it may be thought that the pulverized resin adhering to the disc could be removed by additionally carrying out a cleaning step. However, by doing so, the manufacturing cost will rise by the cost of adding the cleaning step, which makes such a method difficult to adopt.

### SUMMARY OF THE INVENTION

The present invention was conceived in view of the problems described above and it is a principal object of the present invention to provide an applied film forming apparatus and an applied film forming method that can form, without a large increase in manufacturing cost, an applied film with no convex part that protrudes significantly upward at an outer circumferential edge part.

To achieve the above object, an applied film forming apparatus according to the present invention forms an applied film on one surface of a substrate and includes: a dripping unit that drips an energy beam-curing applied material onto the one surface of the substrate; a rotating unit that rotates the substrate; a curing processing unit that emits an energy beam onto the applied material to cure the applied material; an emission regulating unit that regulates emission of the energy beam onto the applied material on an outer circumferential edge part of the one surface; and a control unit, wherein after controlling the dripping unit to drip the applied material onto the one surface and controlling the rotating unit to rotate the substrate and cause the applied material to spread out, the control unit controls the curing processing unit to emit the energy beam toward the one surface and controls the emission regulating unit to regulate the emission of the energy beam onto the applied material on the outer circumferential edge part while controlling the rotating unit to rotate the substrate at a predetermined rotational velocity. It should be noted that the term “cured” in the present specification includes all cured states from a cured state where the fluidity of the applied material has fallen to a cured state where a curing reaction has occurred for all of the applied material.

The applied film forming method according to the present invention spreads out an energy beam-curing applied material on one surface of a substrate and emits an energy beam onto the spread-out applied material to cure the applied material and form an applied film on the one surface, wherein after the applied material is spread out, the energy beam is emitted toward the one surface and emission of the energy beam onto the applied material on an outer circumferential edge part of the one surface is regulated in a state where the substrate is rotated at a predetermined rotational velocity.

According to the above applied film forming apparatus and applied film forming method, after the applied material has been dripped onto the one surface and the substrate has been rotated to cause the applied material to spread out, the energy beam is emitted toward the one surface of the substrate and the emission of the energy beam onto the applied material on the outer circumferential edge part of the one surface of the substrate is regulated in a state where the substrate is rotated at a predetermined rotational velocity. For this reason, by rotating the substrate in a state where the applied material applied to parts of the one surface of the substrate aside from the outer circumferential edge part has been cured, it is possible to push only the small amount of applied material on the outer circumferential edge part outside the substrate by centrifugal force. This means it is possible to suppress the amount of applied material pulled back onto the outer circumferential edge part when the rotation stops to a sufficiently small amount, and as a result it is possible to prevent a large convex part from being formed on the outer circumferential edge part. Since a cutting away process for the applied material after curing can be made unnecessary, a cleaning step of removing the pulverized applied material produced by the cutting away process also becomes unnecessary, and therefore an applied film with no large convex part on an outer circumferential edge part thereof can be formed without causing an increase in the manufacturing cost due to such process and step. Also, by emitting an energy beam in a state where the substrate is rotated, the applied film can be formed with a more uniform thickness compared to a construction that emits an energy beam in a state where the substrate is stopped.

Also, according to the above applied film forming apparatus and applied film forming method, the step of dripping the applied material onto the one surface of the substrate, the step of spreading out the dripped applied material, and the step of emitting the energy beam onto the one surface of the substrate are carried out without changing the position of the substrate, that is, with the substrate positioned at a single location. For this reason, compared to an applied film forming apparatus and applied film forming method that carry out the various steps at different positions, the time taken to form the applied film on the substrate can be reduced by an amount corresponding to the movement of the substrate that is no longer required. Also, by carrying out the various steps with the substrate positioned at a single location, the construction of the entire applied film forming apparatus can be made more compact by an amount corresponding to movement of the substrate no longer being necessary. Additionally, since the construction of the applied film forming apparatus can be simplified by an amount corresponding to a moving device for moving the substrate not being necessary, the cost of the applied film forming apparatus can be kept low.

In this case, the emission regulating unit may include a plurality of shielding members that in a connected state construct a plate-like body in which a circular opening with a slightly smaller diameter than a diameter of the substrate is formed, and a moving mechanism for moving and connecting the shielding members to construct the plate-like body, wherein the control unit may control the movement mechanism to move and connect the shielding members to regulate the emission of the energy beam on the applied material on the outer circumferential edge part. It is also possible to use a method where the emission of the energy beam onto the applied material on the outer circumferential edge part is regulated by connecting a plurality of shielding members that in a connected state construct a plate-like body in which a circular opening with a slightly smaller diameter than a diameter of the substrate is formed. According to this applied film forming apparatus and applied film forming method, compared to a construction where the shielding members are formed as an integral body, for example, it is possible to reduce the area of a withdrawal position of the shielding members when the shielding members are not in use and therefore a corresponding reduction can be made in the size of the applied film forming apparatus.

It is also possible to use a construction where gaps between the respective shielding members in the connected state and the outer circumferential edge part are respectively in a range of 2 mm to 10 mm, inclusive. It is also possible to use a method where the respective shielding members are connected so that gaps between the respective shielding members in the connected state and the outer circumferential edge part are respectively in a range of 2 mm to 10 mm, inclusive. According to this applied film forming apparatus and applied film forming method, it is possible to reliably regulate the emission of the energy beam onto the applied material on the outer circumferential edge part. Also, even if the substrate vibrates due to rotation, for example, it is possible to reliably avoid contact between the outer circumferential edge part and the shielding members.

It is also possible to use a construction including a wall part that is disposed close to a side surface of the substrate during spreading out and causes the applied material that protrudes outside the substrate to flow downward along the side surface of the substrate. In the applied film forming method also, a wall part may be disposed close to a side surface of the substrate during spreading out and may cause the applied material that protrudes outside the substrate to flow downward along the side surface of the substrate. According to this applied film forming apparatus and applied film forming method, an applied film that is continuous from the surface to the side surface of the substrate can be formed. For this reason, it is possible to reliably prevent the applied film from becoming detached from the substrate due to an impact or contact with an object. In addition, since the applied film is formed on the side surface of the substrate, it is possible to reliably prevent damage to the side surface due to an impact or contact with an object.

It should be noted that the disclosure of the present invention relates to a content of Japanese Patent Application 2004-290789 that was filed on Oct. 1, 2004 and the entire content of which is herein incorporated by reference.

### BRIEF DESCRIPTION OF THE DRAWINGS

These and other objects and features of the present invention will be explained in more detail below with reference to the attached drawings, wherein:

FIG. 1 is a cross-sectional view of an optical recording medium;

FIG. 2 is a block diagram showing the construction of a manufacturing apparatus;

FIG. 3 is a block diagram showing the construction of a resin layer forming device;

FIG. 4 is a cross-sectional view of a preform;

FIG. 5 is a perspective view of shielding members in a state where the shielding members are separated from one another;

FIG. 6 is a perspective view of the shielding members in a state where the shielding members are connected to one another;

FIG. 7 is a plan view of a resin layer forming device in an initial state;

FIG. 8 is a cross-sectional view of the resin layer forming device in the initial state;

FIG. 9 is a cross-sectional view of a moving mechanism in an initial state;

FIG. 10 is a graph showing the relationship between a timetable for executing various steps and a rotational velocity of the motor;

FIG. 11 is a plan view of the resin layer forming device in a state where the shielding members are connected;

FIG. 12 is a cross-sectional view of the resin layer forming device in the state where the shielding members are connected;

FIG. 13 is a cross-sectional view of a substrate in a state where the substrate is further rotated after emission of UV rays;

FIG. 14 is a cross-sectional view of the substrate in a state where rotation has stopped;

FIG. 15 is a cross-sectional view of another resin layer forming device;

FIG. 16 is a cross-sectional view of a substrate and a wall part in a state where the resin material has been spread out;

FIG. 17 is a cross-sectional view of another information recording medium; and

FIG. 18 is a cross-sectional view of yet another resin layer forming device.

### DESCRIPTION OF THE PREFERRED EMBODIMENTS

Preferred embodiments of an applied film forming apparatus and an applied film forming method according to the present invention will now be described with reference to the attached drawings.

First, the construction of an optical recording medium 1 will be described with reference to the drawings.

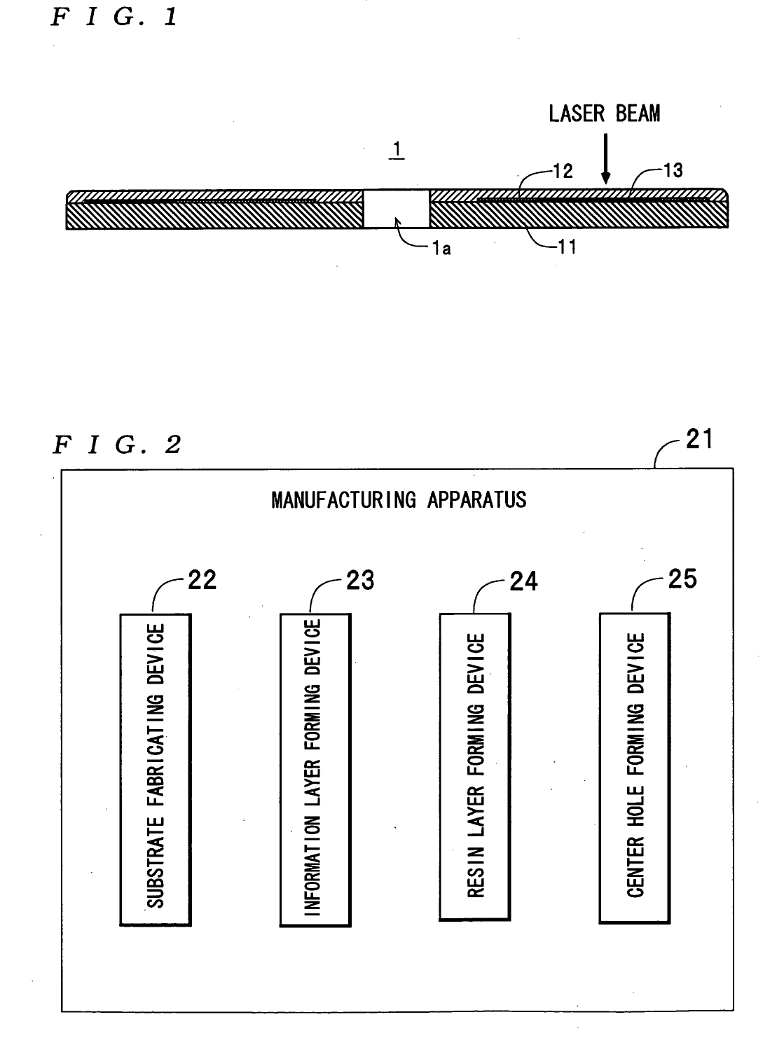

As shown in FIG. 1, the optical recording medium (information recording medium) 1 is constructed with an information layer 12 as a principal functional layer and a resin layer 13 (an “applied film” for the present invention) formed so as to cover the information layer 12 laminated on a surface (“one surface” for the present invention) side of a substrate 11 so that data can be recorded and read by emitting a laser beam from the resin layer 13 side. In addition, the optical recording medium 1 is formed with an attachment center hole 1a with a diameter of around 15 mm in a center thereof. In this case, as shown in FIG. 4, the attachment center hole 1a is formed by punching out a center part of a preform 2 where the information layer 12 and the resin layer 13 are formed on the substrate 11. The substrate 11 is fabricated by injection molding polycarbonate, for example, using a substrate fabricating device 22 of a manufacturing apparatus 21 (see FIG. 2) described later. In this case, as one example, the substrate 11 is formed in a disc-like shape (a flat plate-like shape) with a diameter of around 120 mm and a thickness of around 1.2 mm, for example. Also, as shown in FIG. 4, a concave part 11a, which is circular in planar form and will later compose part of the attachment center hole 1a, is formed at a center in a rear surface side (the lower surface side in FIG. 4) of the substrate 11 before the attachment center hole 1a is formed by punching out, and a cylindrical protrusion 11b in the form of a cylinder is formed in a surface side (the “one surface” for the present invention, and the upper surface in FIG. 4) thereof. Also, a groove pattern (not shown) with arrangement pitch of around 0.32 μm, for example, is formed in a surface of the substrate 11.

As one example, the information layer 12 is a functional layer composed of a reflective layer, a dielectric layer, a phase-change-type recording layer, and the like, and is formed using an information layer forming device 23 (see FIG. 2) of the manufacturing apparatus 21. The resin layer 13 functions as a light-transmitting layer and is formed in accordance with an applied film forming method according to the present invention using a resin layer forming device 24 (see FIG. 2) of the manufacturing apparatus 21. In this case, the resin layer 13 is formed with a thickness set at 100 μm, as one example.

Next, the construction of the manufacturing apparatus 21 for manufacturing the optical recording medium 1 will be described with reference to the drawings.

As shown in FIG. 2, the manufacturing apparatus 21 includes the substrate fabricating device 22, the information layer forming device 23, the resin layer forming device 24, and a center hole forming device 25. The substrate fabricating device 22 is composed of an injection molding device, for example, and fabricates the substrate 11 shown in FIG. 4 by injection molding. The information layer forming device 23 is composed of a sputtering device, for example, and forms the information layer 12 by sputtering.

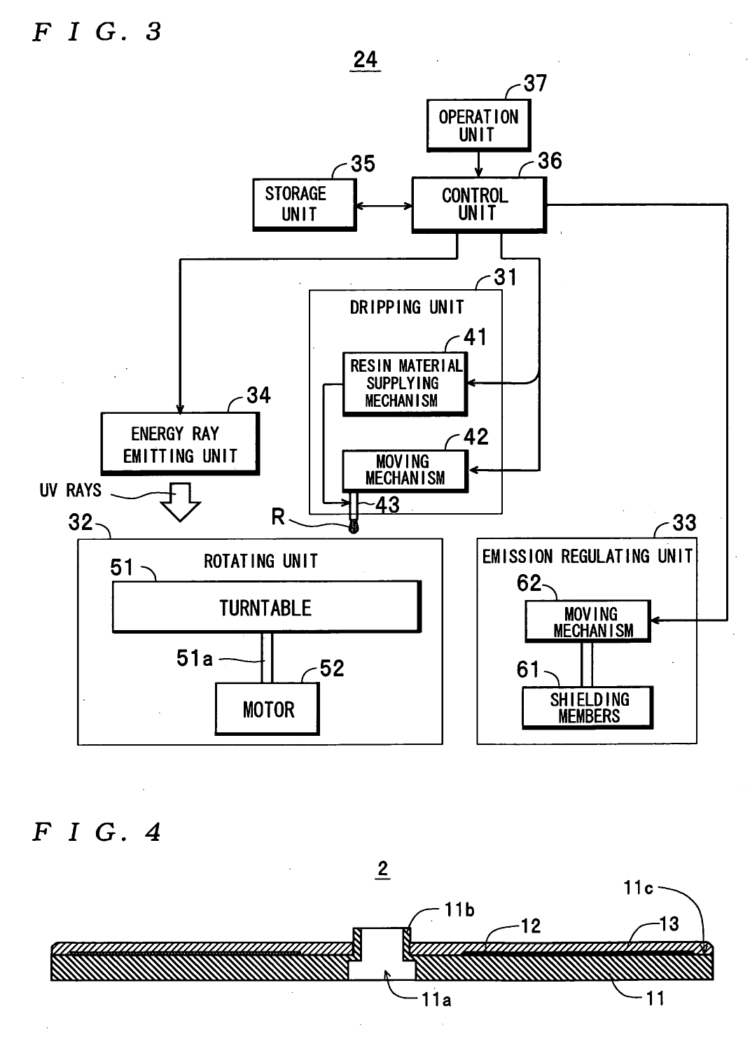

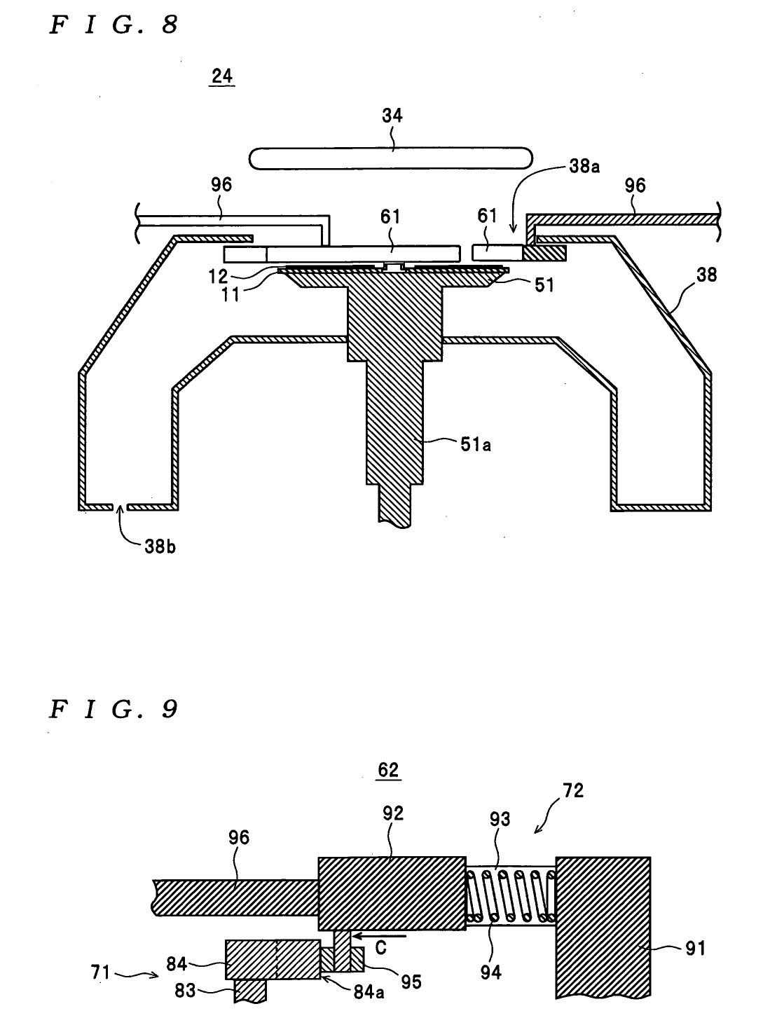

The resin layer forming device 24 corresponds to the applied film forming apparatus according to the present invention, and as shown in FIG. 3, is composed of a dripping unit 31, a rotating unit 32, an emission regulating unit 33, an energy ray emitting unit 34, a storage unit 35, a control unit 36, an operation unit 37, and a cover 38 (FIG. 8), and forms the resin layer 13 according to the applied film forming method according to the present invention. As shown in FIG. 3, the dripping unit 31 includes a resin material supplying mechanism 41, a moving mechanism 42, and an expelling nozzle 43. The resin material supplying mechanism 41 is controlled by the control unit 36 to supply a UV-curing resin material R (an “energy ray-curing applied material” for the present invention, and as one example, urethane acrylate) for forming the resin layer 13 and thereby has the resin material R expelled from the expelling nozzle 43 so that the resin material R drips onto the substrate 11 (the information layer 12). The moving mechanism 42 is controlled by the control unit 36 and moves the expelling nozzle 43 above a turntable 51 (or more precisely, the substrate 11 mounted on the turntable 11) of the rotating unit 32.

As shown in FIG. 3, the rotating unit 32 includes the turntable 51 and a motor 52. The turntable 51 is formed in an overall disc-like shape and as shown in FIG. 8 is housed inside the cover 38. In addition, a shaft 51a connected to a rotational shaft (not shown) of the motor 52 is attached to a center of a lower surface of the turntable 51. The motor 52 is controlled by the control unit 36 and rotates the turntable 51.

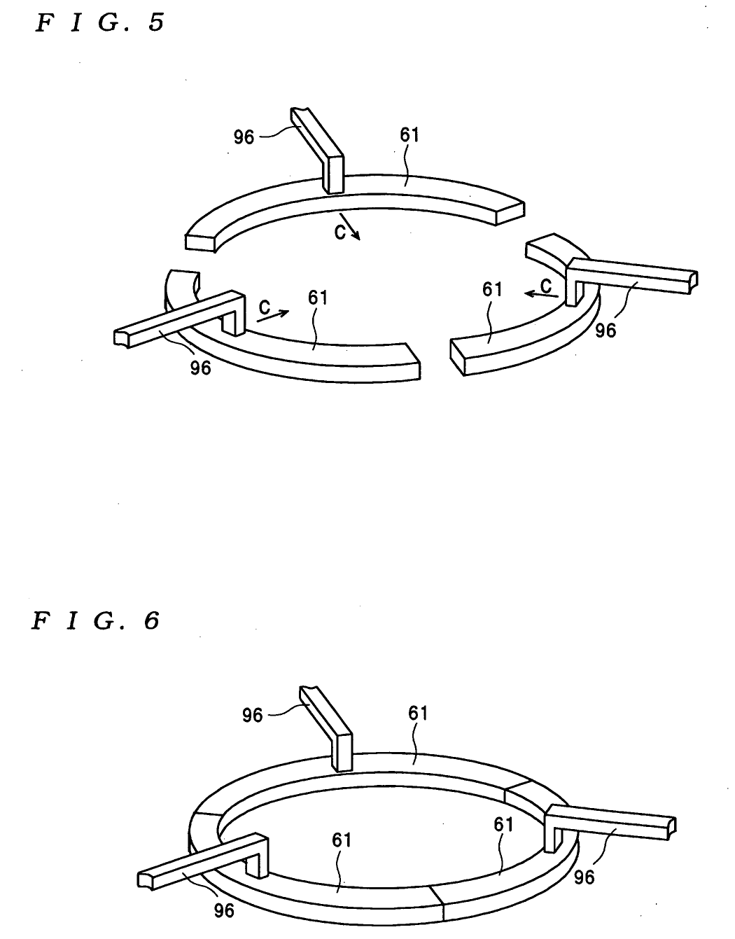

As shown in FIG. 3, the emission regulating unit 33 includes shielding members 61 (see FIG. 5 also) and a moving mechanism 62, and regulates the emission of UV rays from the energy ray emitting unit 34 onto the resin material R on the outer circumferential edge part (hereinafter referred to as the “surface outer circumferential edge part 11c”) of the surface of the substrate 11. As shown in FIG. 5, the shielding members 61 are respectively formed of a UV-shielding material such as metal so as to be arc-shaped in planar form, and are connectable to one another. In addition, as shown in FIG. 6, the shielding members 61 are formed so that in a connected state, the shielding members 61 form an annular body (one example of a “plate-like body” for the present invention) that has a circular opening in a center thereof. In this case, to prevent curing of the resin material R that protrudes outside the substrate 11 when the resin material R is spread out as described later, the curvature and lengths of the shielding members 61 are set so that in the connected state, the shielding members 61 construct an annular body (one example of a “plate-like body” for the present invention) where the outer diameter is slightly larger than the diameter of the substrate 11 (as one example, around 125 mm) and an inner diameter of the circular opening (the “diameter of the circular opening” for the present invention) is smaller (only slightly smaller at around 118 mm, for example) than the diameter of the substrate 11.

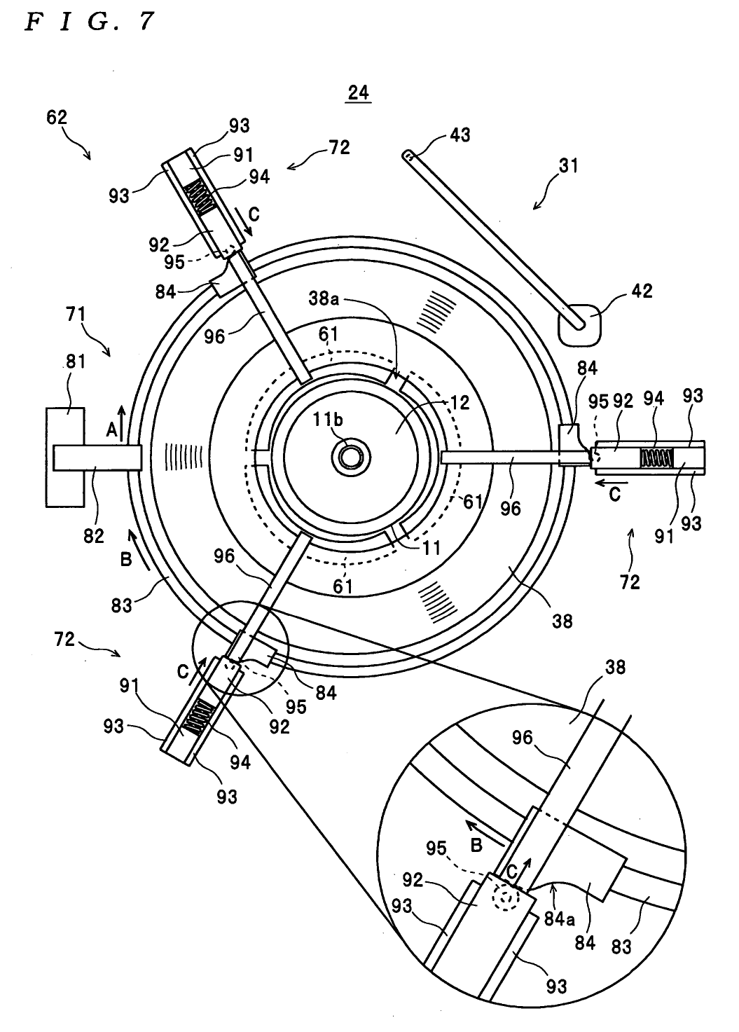

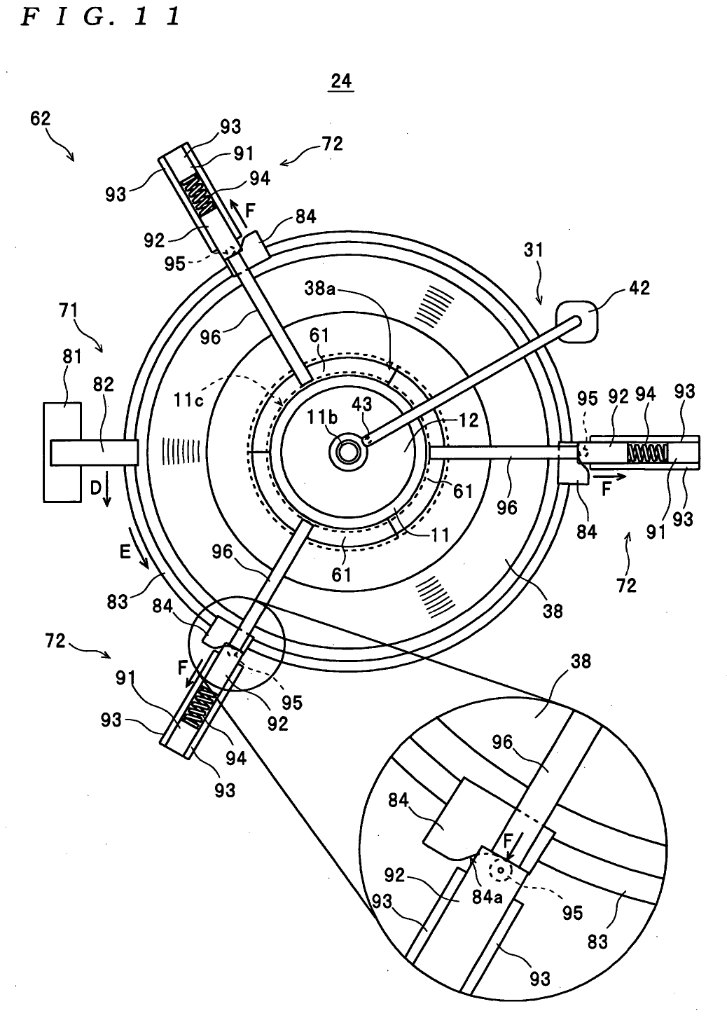

The moving mechanism 62 corresponds to a “moving mechanism” for the present invention and as shown in FIG. 7, includes a cam mechanism 71 and three pressing mechanisms 72. By moving the shielding members 61, the moving mechanism 62 connects the shielding members 61 together. As shown in FIG. 7, the cam mechanism 71 includes an air cylinder 81, an arm 82, a ring 83, and plate cams 84. The air cylinder 81 operates according to air supplied via an electromagnetic valve, not shown, that is driven under the control of the control unit 36 to move the arm 82 in the directions of the arrows A and D respectively shown in FIGS. 7 and 11. The ring 83 is disposed so as to surround the cover 38 and is caused to revolve in the directions shown by the arrows B and E respectively shown in FIGS. 7 and 11 by movement of the arm 82. The plate cams 84 are fixed to the ring 83 at equal intervals and therefore move together with the revolving of the ring 83.

As shown in FIGS. 7 and 9, the pressing mechanisms 72 each include a base part 91, a slide part 92, a guide part 93, a coil spring 94, a cam follower 95, and a rod 96. The base parts 91 are disposed at equal intervals around an outside of the ring 83. Each slide part 92 slides in a direction so as to move toward and away from the center of the cover 38 while being guided by the guide part 93 that is attached to the base part 91. Each coil spring 94 is disposed between the base part 91 and the slide part 92, and presses the slide part 92 toward the center of the cover 38. As shown in FIG. 9, each cam follower 95 is attached to a lower surface of one of the slide parts 92, contacts a side surface 84a of one of the plate cams 84 of the cam mechanisms 71 and moves together with the movement of the plate cam 84, thereby causing the slide part 92 to slide in directions toward and away from the center of the cover 38. A base end of each rod 96 is fixed to one of the slide parts 92. A front end of each rod 96 is fixed to one of the shielding members 61. In this case, in a state where the substrate 11 is mounted on the turntable 51, when the gap between the surface outer circumferential edge part 11c and the respective shielding members 61 that are in the connected state exceeds 10 mm, it is difficult to reliably regulate the emission of UV rays onto the resin material R on the surface outer circumferential edge part 11c. On the other hand, when the gap is below 2 mm, there is the risk of the substrate 11 mounted on the turntable 51 contacting one of the shielding members 61 due to vibration and the like when the substrate 11 rotates. Accordingly, the disposed positions of the respective pressing mechanisms 72 are set so that the gap described above is around 5 mm (one example of a value in “a range of 2 mm to 10 mm inclusive” for the present invention).

The energy ray emitting unit 34 corresponds to a “curing processing unit” for the present invention and as shown in FIG. 8, is disposed above the turntable 51 and the cover 38 and, in accordance with control by the control unit 36, emits UV rays (one example of “energy rays” for the present invention) toward the substrate 11 mounted on the turntable 51 to cure the resin material R applied onto the surface of the substrate 11. The storage unit 35 stores a formation condition table in which formation conditions required for forming the resin layer 13, such as a supplied amount of the resin material R, a rotational velocity (rpm) and rotation time of the turntable 51, movement timing for moving the shielding members 61, and an emitted amount of the UV rays, are written. The control unit 36 reads the formation conditions corresponding to the intended thickness value of the resin layer 13 set by operating the operation unit 37 and controls the dripping unit 31, the rotating unit 32, the emission regulating unit 33, and the energy ray emitting unit 34 in accordance with the read formation conditions. The operation unit 37 includes various types of operation buttons such as input buttons for inputting an intended thickness value for the resin layer 13, and outputs operation signals corresponding to operations of the operation buttons to the control unit 36. The cover 38 prevents scattering of the resin material R when the resin material R is spread out. As shown in FIG. 8, the turntable 51 of the rotating unit 32 is housed inside the cover 38. Also, an opening 38a used when mounting the substrate 11 on the turntable 51 is formed in an upper part of the cover 38 and a suction opening 38b for sucking air from inside the cover 38 is formed in a lower part of the cover 38.

In this case, in the resin layer forming device 24, the dripping of the resin material R onto the surface of the substrate 11, the spreading of the dripped resin material R, and the emission of the UV rays toward the surface of the substrate 11 are carried out without moving the substrate 11 from the turntable 51, that is, in a state where the substrate 11 is mounted on the turntable 51. For this reason, compared to an applied film forming apparatus that carries out the various steps at different positions, the construction of the entire resin layer forming device 24 can be made more compact by an amount corresponding to movement of the substrate 11 no longer being necessary. Also, since the construction of the resin layer forming device 24 can be simplified by an amount corresponding to a moving device for moving the substrate 11 not being necessary, the cost of the resin layer forming device 24 can be kept low.

The center hole forming device 25 includes, for example, a tubular punching-out blade, a moving mechanism that raises and lowers the punching-out blade, and an ultrasonic generator for ultrasonically vibrating the punching-out blade (none of such components is shown), and forms the attachment center hole 1a by punching out a part of the preform 2 (see FIG. 4) where the concave part 11a is formed.

Next, a manufacturing method that manufactures the optical recording medium 1 using the manufacturing apparatus 21 will be described with reference to the drawings, focusing on the method (the applied film forming method according to the present invention) that forms the resin layer 13 using the resin layer forming device 24.

First, using the substrate fabricating device 22 of the manufacturing apparatus 21, the substrate 11 is fabricated by injection molding polycarbonate, for example. In this case, a convex/concave pattern of a stamper set inside an injection molding mold (neither is shown) of the substrate fabricating device 22 is transferred to form a groove pattern in the surface side of the substrate 11. Next, using the information layer forming device 23 of the manufacturing apparatus 21, the reflective layer, the dielectric layer, the phase-change-type recording layer, and another dielectric layer are laminated in that order on the surface of the substrate 11 by sputtering to form the information layer 12.

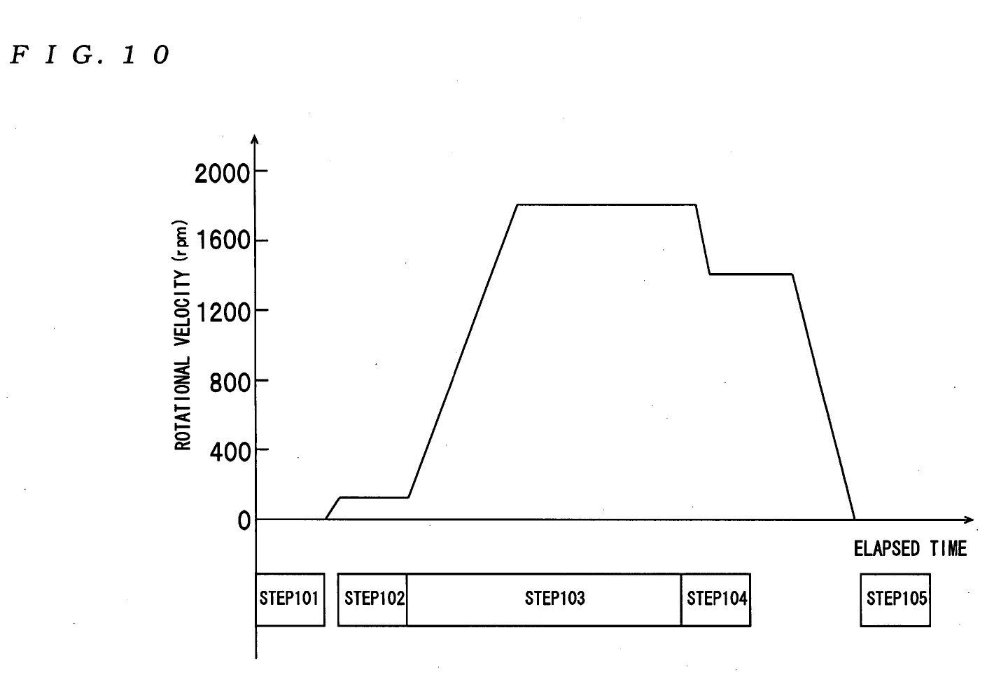

Next, using the resin layer forming device 24 of the manufacturing apparatus 21, the resin layer 13 is formed on the substrate 11 so as to cover the information layer 12. More specifically, as shown in FIGS. 7 and 8, the substrate 11 is inserted from the opening 38a of the cover 38 and mounted on the turntable 51 of the rotating unit 32 in a state where the surface on which the information layer 12 has been formed faces upward. Next, the operation unit 37 is operated to input the intended thickness value (in the example described above, 100 μm) of the resin layer 13. Corresponding to this, the control unit 36 reads the formation conditions corresponding to the intended thickness value 100 μm from the storage unit 35. Next, the control unit 36 controls the dripping unit 31, the rotating unit 32, the emission regulating unit 33, and the energy ray emitting unit 34 in accordance with the read forming conditions using a timetable shown in FIG. 10.

In this case, the control unit 36 first controls the emission regulating unit 33 to have a shield member moving step (step 101 in FIG. 10) executed. More specifically, the control unit 36 controls the electromagnetic valve of the cam mechanism 71 in the moving mechanism 62 of the emission regulating unit 33 to supply air to one air supply opening of the air cylinder 81 shown in FIG. 7. In this case, the air cylinder 81 operates due to the air being supplied and moves the arm 82 in the direction of the arrow A shown in FIG. 7. At this time, the ring 83 is caused to revolve in the direction of the arrow B shown in FIG. 7 due to the movement of the arm 82, and the plate cams 84 that are fixed to the ring 83 also move in the direction of the arrow B together with the revolving of the ring 83. In each pressing mechanism 72, as shown in FIGS. 7 and 9, the cam follower 95 attached to the slide part 92 that is pressed toward the center of the cover 38 by the coil spring 94 strikes the side surface 84a of the plate cam 84 and is moved in the direction of the arrows C toward the center of the cover 38 together with the movement of the plate cams 84, with the slide part 92 being guided by the guide part 93 and moving in the direction of the arrows C together with the movement of the cam follower 95. By doing so, as shown in FIG. 7, the shielding members 61 fixed to the front ends of the rods 96 move in the direction of the arrows C and as shown in FIGS. 11 and 12, the shielding members 61 are connected to one another to construct an annular body above the surface outer circumferential edge part 11c of the substrate 11 (between the substrate 11 and the energy ray emitting unit 34). In this case, narrow gaps of around 5 mm are formed between the surface outer circumferential edge part 11c of the substrate 11 and the respective shielding members 61 and between the edge of the opening 38a of the cover 38 and the respective shielding members 61. Note that the sizes of the gaps have been exaggerated in FIG. 12.

Next, the control unit 36 drives a suction pump, not shown, that is connected to the suction opening 38b of the cover 38. At this time, as air (gas) inside the cover 38 is sucked out from the suction opening 38b, outside air flows into the cover 38 from the gaps between the surface outer circumferential edge part 11c of the substrate 11 and the respective shielding members 61 and the gaps between the edge of the opening 38a of the cover 38 and the respective shielding members 61. Next, the control unit 36 controls the motor 52 of the rotating unit 32 and as shown in FIG. 10, the turntable 51 is rotated at a low rotational velocity of 120 rpm, for example. Next, the control unit 36 controls the dripping unit 31 to carry out a dripping step (step 102 in FIG. 10). In this case, the control unit 36 controls the moving mechanism 42 of the dripping unit 31 and after the moving mechanism 42 has moved the expelling nozzle 43 above the center of the substrate 11 as shown in FIG. 11, controls the resin material supplying mechanism 41 to supply a predetermined amount of the resin material R to the expelling nozzle 43. By doing so, the resin material R is expelled from the expelling nozzle 43 and the resin material R is dripped onto a center of the substrate 11 that rotates together with the rotation of the turntable 51.

Next, the control unit 36 controls the rotating unit 32 to have a spreading step (step 103 shown in FIG. 10) carried out. In this case, as shown in FIG. 10, the control unit 36 increases the rotational velocity of the motor 52 to cause the turntable 51 to rotate at a high rotational velocity (for example, 1700 rpm) suited to spreading out the resin material R with a substantially uniform thickness. At this time, the resin material R is spread out with a substantially uniform thickness toward the surface outer circumferential edge part 11c of the substrate 11 by the centrifugal force that accompanies the rotation. In this case, since the gaps between the surface outer circumferential edge part 11c and the respective shielding members 61 are narrow as described above, the air that passes through the gaps flows at high speed. As a result, resin material R that is scattered toward the outside of the substrate 11 by the centrifugal force during spreading moves toward a lower part of the cover 38, and therefore the resin material R is reliably prevented from adhering to the shielding members 61.

Next, the control unit 36 controls the rotating unit 32 and the energy ray emitting unit 34 to have a first curing step (step 104 shown in FIG. 10) executed. In this case, the control unit 36 has the rotational velocity of the motor 52 in the rotating unit 32 maintained at a high rotational velocity (1700 rpm) and controls the energy ray emitting unit 34 to have UV rays emitted toward the resin material R (the substrate 11). At this time, as shown in FIG. 12, the resin material R applied to a part of the substrate 11 aside from the surface outer circumferential edge part 11c is gradually cured by the emitted UV rays. On the other hand, since emission of the UV rays onto the resin material R on the surface outer circumferential edge part 11c of the substrate 11 is regulated by the shielding members 61, such resin material R maintains a fluid state. In this case, as described above, by setting the gaps between the surface outer circumferential edge part 11c of the substrate 11 and the respective shielding members 61 so that the gaps are around 5 mm, the emission of UV rays onto the resin material R on the surface outer circumferential edge part 11c is reliably regulated, and even if the substrate 11 vibrates due to rotation, for example, it is possible to reliably avoid contact between the surface outer circumferential edge part 11c and the shielding members 61.

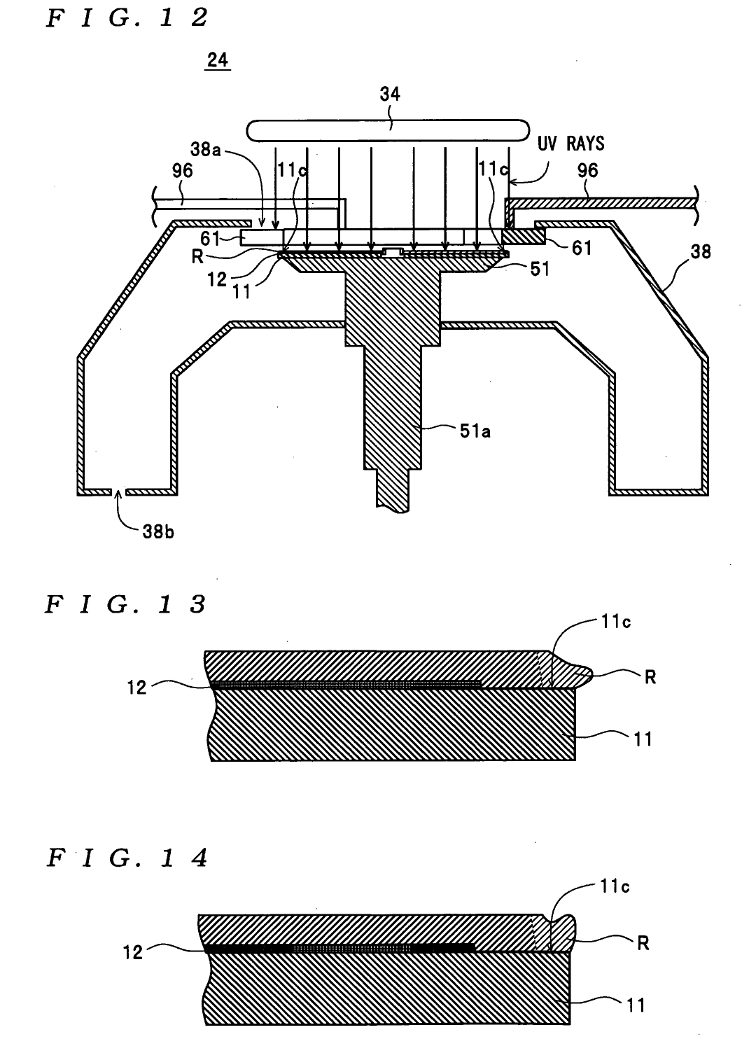

Next, the control unit 36 controls the energy ray emitting unit 34 to maintain the emission of UV rays and has the rotational velocity of the motor 52 reduced to an intermediate velocity (for example, 1400 rpm). Next, after having the emission of UV rays by the energy ray emitting unit 34 stopped, the control unit 36 has the motor 52 maintain the rotational velocity of 1400 rpm for a predetermined period. At this time, as shown in FIG. 13, the resin material R on the surface outer circumferential edge part 11c that is still fluid is pushed further out than the substrate 11 by the centrifugal force due to the rotation, and the thickness thereof becomes thinner than the resin material R of other parts of the substrate 11. Next, the control unit 36 has the motor 52 stop rotating. At this time, as shown in FIG. 14, the resin material R pushed further out than the substrate 11 is pulled back toward the surface outer circumferential edge part 11c by surface tension when the motor 52 is stopped. In this case, since the pulled-back amount of resin material R is little and the thickness of the resin material R is thinner at the surface outer circumferential edge part 11c than at other parts, a state where no convex part that significantly protrudes upward is present in the resin material R at the surface outer circumferential edge part 11c is maintained.

Next, the control unit 36 controls the electromagnetic valve of the cam mechanism 71 of the moving mechanism 62 so that air is supplied to another air supply opening of the air cylinder 81 shown in FIG. 11. Next, due to the air being supplied, the air cylinder 81 moves the arm 82 in the direction shown by the arrow D in FIG. 11 and therefore the ring 83 and the plate cams 84 fixed to the ring 83 are caused to revolve (move) in the direction shown by the arrow E in FIG. 11 by the movement of the arm 82. In addition, in the respective pressing mechanisms 72, the cam follower 95 that is pressed toward the center of the cover 38 by the coil spring 94 strikes the side surface 84a of one of the plate cams 84 and in accordance with the movement of the plate cam 84 is caused to move in opposition to the pressing force of the coil spring 94 in a direction (the direction of the arrows F in FIG. 11) away from the center of the cover 38. For this reason, the slide part 92 is caused to slide in a direction of the arrows F in accordance with the movement of the cam follower 95. As a result, the shielding members 61 that constructed the annular body move away from one another in accordance with the movement of the slide parts 92 and are moved to the positions in an initial state shown in FIGS. 7 and 8.

Next, the control unit 36 controls the energy ray emitting unit 34 to have a second curing step (step 105 shown in FIG. 10) carried out where UV rays are emitted for a predetermined time toward the resin material R. At this time, since the shielding members 61 have been moved to the positions in the initial state, UV rays are emitted onto the resin material R on the surface outer circumferential edge part 11c and the resin material R on the surface of the substrate 11 is completely (or substantially completely) cured to form the resin layer 13. In this case, as described above, since a state is maintained where no convex part that significantly protrudes upward is present in the resin material R on the surface outer circumferential edge part 11c, the resin layer 13 is formed with no convex part that significantly protrudes upward at the outer circumferential part.

In this case, in the method of forming the resin layer 13 (the applied film forming method according to the present invention), the dripping step (step 102 shown in FIG. 10) of dripping a resin material R onto the surface of the substrate 11, the spreading step (step 103 shown in FIG. 10) that spreads the dripped resin material R, and the first curing step and the second curing step (steps 104, 105 shown in FIG. 10) that emit UV rays towards the surface of the substrate 11 to cure the resin material R are all carried out without moving the substrate 11 from the turntable 51, that is, in a state where the substrate 11 is mounted on the turntable 51. For this reason, compared to an applied film forming method where the respective steps are carried out at different positions, the time taken to form the resin layer 13 can be reduced by an amount corresponding to the movement of the substrate 11 that is no longer required.

Next, the substrate 11 is removed from the turntable 51 and taken out of the opening 38a of the cover 38. By doing so, as shown in FIG. 4, the preform 2 is completed. Next, using the center hole forming device 25 of the manufacturing apparatus 21, a part of the preform 2 where the concave part 11a is formed is punched out to form the attachment center hole 1a. By doing so, the optical recording medium 1 is completed.

In this way, according to the resin layer forming device 24 and the applied film forming method, after the resin material R is dripped onto the surface of the substrate 11 and the substrate 11 has been rotated to spread out the resin material R, UV rays are emitted toward the surface of the substrate 11 in a state where the substrate 11 is rotated at a predetermined rotational velocity and the emission of UV rays onto the resin material R on the surface outer circumferential edge part 11c is regulated, so that by rotating the substrate 11 in a state where the resin material R applied to parts of the substrate 11 aside from the surface outer circumferential edge part 11c has been cured, only the small amount of resin material R on the surface outer circumferential edge part 11c is pushed out beyond the substrate 11 by centrifugal force. For this reason, it is possible to suppress the amount of resin material R pulled back toward the surface outer circumferential edge part 11c when the rotation is stopped to a sufficiently small amount, and as a result, it is possible to prevent a large convex part from being formed on the surface outer circumferential edge part 11c. Since a cutting away process for the resin material R after curing can be made unnecessary, a cleaning step of removing the pulverized applied material produced by the cutting away process also becomes unnecessary, and therefore the resin layer 13 with no large convex part on the surface outer circumferential edge part 11c can be formed without causing an increase in the manufacturing cost due to such process and step. Also, by emitting UV rays in a state where the substrate 11 is rotated, the resin layer 13 can be formed with a more uniform thickness compared to a construction that emits UV rays in a state where the substrate 11 is stopped.

Also, according to the resin layer forming device 24 and the applied film forming method, the dripping step that drips the resin material R onto the surface of the substrate 11, the spreading step of spreading out the dripped resin material R, and the first curing step and second curing step that cure the resin material R by emitting UV rays toward the surface of the substrate 11 are carried out without moving the substrate 11 from the turntable 51, i.e., in a state where the substrate 11 is mounted on the turntable 51. For this reason, compared to an applied film forming apparatus and an applied film forming method where the respective steps are carried out at different positions, the time taken to form the resin layer 13 can be reduced by an amount corresponding to the movement of the substrate 11 that is no longer required. Also, since the respective steps are carried out with the substrate 11 mounted on the turntable 51, compared to an applied film forming apparatus that carries out the various steps at different positions, the construction of the entire resin layer forming device 24 can be made more compact by an amount corresponding to the movement of the substrate 11 that is no longer necessary. Also, since the construction of the resin layer forming device 24 can be simplified by not requiring a moving device for moving the substrate 11, the cost of the resin layer forming device 24 can be suppressed.

By regulating the emission of UV-rays onto the resin material R on the surface outer circumferential edge part 11c by connecting the shielding members 61 that in a connected state construct the annular body, compared to a construction where the shielding members 61 are formed as an integral body, for example, it is possible to reduce the area of a withdrawal position of the shielding members 61 when the shielding members 61 are not in use and therefore a corresponding reduction can be made in the size of the resin layer forming device 24.

Also, by connecting the respective shielding members 61 so that the gaps between the shielding members 61 in the connected state and the surface outer circumferential edge part 11c of the substrate 11 are around 5 mm that is in a range of 2 mm to 10 mm, inclusive, it is possible to reliably regulate the emission of UV rays onto the resin material R on the surface outer circumferential edge part 11c. It is also possible to reliably avoid contact between the shielding members 61 and the surface outer circumferential edge part 11c even if the substrate 11 vibrates due to the rotation, for example.

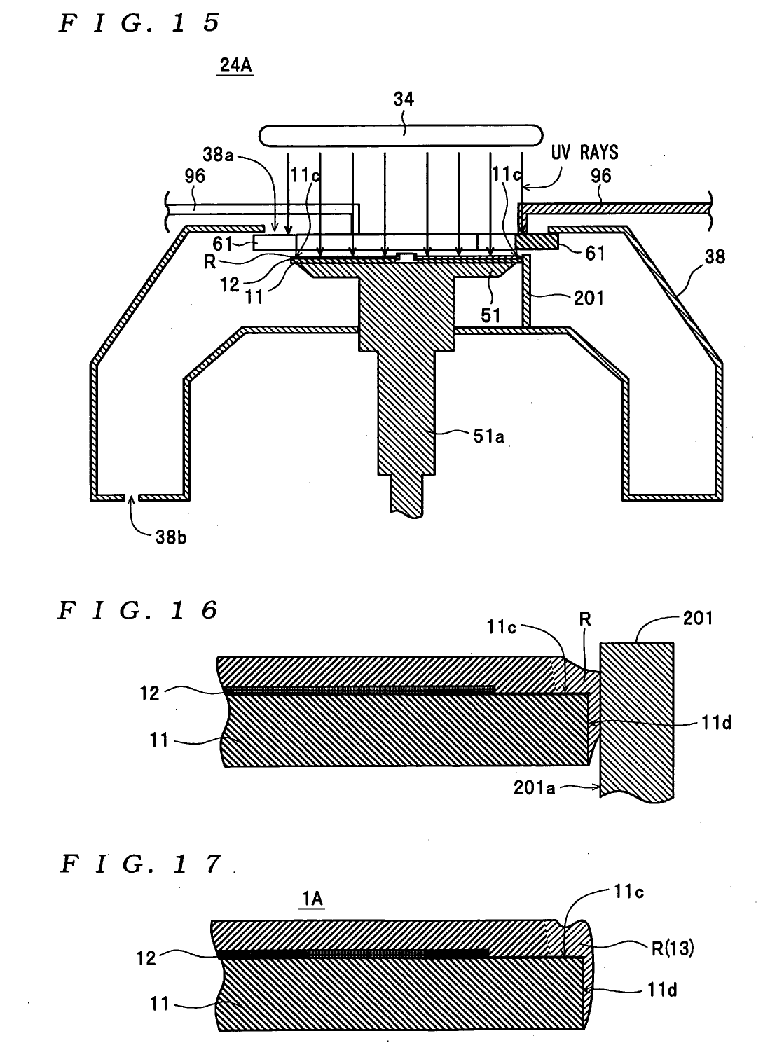

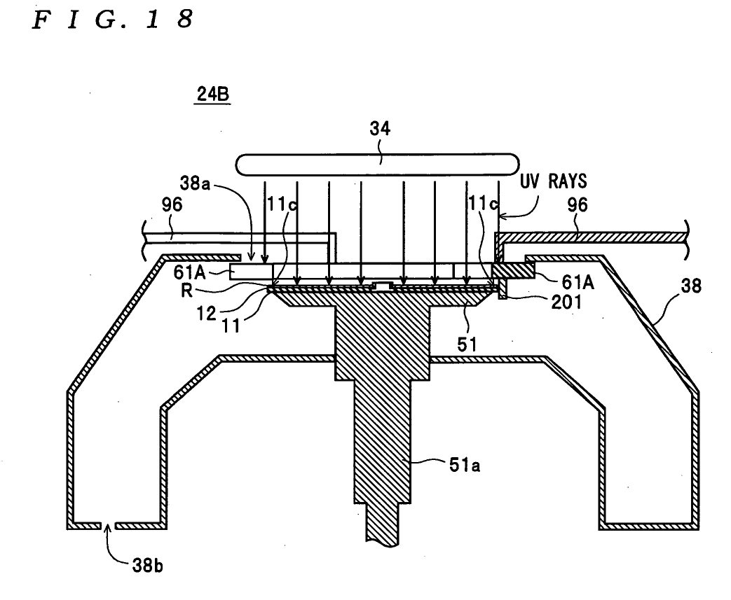

It should be noted that the present invention is not limited to the construction and method described above. For example, it is also possible to use a resin layer forming device 24A shown in FIG. 15 and an applied film forming method that uses the resin layer forming device 24A. It should be noted that in the following description, component elements that are the same as in the resin layer forming device 24 are designated using the same reference numerals and duplicated description thereof is omitted. As shown in FIG. 15, the resin layer forming device 24A is constructed so as to include a wall part 201 disposed inside the cover 38 close to a side surface 11d (see FIG. 16) of the substrate 11 mounted on the turntable 51. In this case, as shown in FIG. 16, the wall part 201 is disposed so that a gap of around 1 mm, for example, is produced between the side surface 11d of the substrate 11 and a wall surface 201a of the wall part 201. In the resin layer forming device 24A, as shown in FIG. 16, when the resin material R is spread out, since the wall part 201 is disposed close to the side surface 11d of the substrate 11, the resin material R that protrudes outside the substrate 11 due to the centrifugal force caused by the rotation of the substrate 11 (the motor 52) flows down along the side surface 11d at the gap between the side surface 11d and the wall surface 201a. For this reason, when the rotation of the substrate 11 has stopped, as shown in FIG. 17, resin material R is applied on the side surface 11d of the substrate 11. Accordingly, when an optical recording medium 1A is completed, as shown in FIG. 17, the resin layer 13 is formed so as to be continuous from the surface of the substrate 11 to the side surface 11d. According to the resin layer forming device 24A and the applied film forming method, when the resin material R is spread out, the wall part 201 is close to the side surface 11d of the substrate 11 and therefore the resin material R flows downward along the side surface 11d. This means that the resin layer 13 is formed continuously from the surface to the side surface 11d of the substrate 11 and therefore it is possible to reliably prevent the resin layer 13 from becoming detached from the substrate 11 due to an impact or contact with an object, for example. In addition, since the resin layer 13 is formed on the side surface 11d of the substrate 11, it is possible to reliably prevent damage to the side surface 11d due to an impact or contact with an object, for example.

Also, as shown in FIG. 18, in place of the shielding members 61 of the resin layer forming device 24, it is possible to use a resin layer forming device 24B that includes shielding members 61A with the wall part 201 disposed on a lower surface thereof. Also, although an example constructed so that the emission of UV rays is regulated in a state where three shielding members 61 are connected above the surface outer circumferential edge part 11c of the substrate 11 has been described, the number of shielding members is not limited to three, and the number can be set at any free-chosen number that is two or greater. Also, in place of the shielding members 61 that have a divided construction, it is possible to use a construction where an annular body is integrally formed with the same shape as the shielding members 61 in the connected state and is used to block the UV rays.

Also, the applied material for the present invention is not limited to the UV-curing resin material R described above, and electron-beam curing resin materials and thermal curing resin materials are also included. Also, the applied material is not limited to resin and the applied material of the present invention also includes various types of organic material. In this case, an energy beam emitting unit that can emit an electron beam or heat rays as an energy beam for curing the resin is used in place of the energy ray emitting unit 34, and by using shielding members that can shield against such energy beam, the resin layer 13 can be formed of the various types of applied materials mentioned above. In addition, although an example where the resin layer 13 that functions as a light-transmitting layer is positioned on the laser-beam emitting side of the substrate has been described, the present invention can be applied when an applied film that functions as a cover layer or the like is formed. Also, although an example has been described for the case when manufacturing the optical recording medium 1 on which only one information layer 12 is formed, the present invention can be applied to forming a spacer layer between respective information layers in a manufacturing process that manufactures a multilayer information recording medium on which a plurality of information layers are formed.

Also, although an example has been described above where the present invention is applied to manufacturing the optical recording medium 1 including the information layer 12 constructed of a reflective layer, a dielectric layer, a phase-change type recording layer, and the like, it is also possible to apply the present invention to manufacturing an information recording medium with a write-once information layer or a read-only information recording medium where a convex/concave pattern for information is formed in the surface of a substrate and a spacer layer.

What is claimed is:

1. An applied film forming apparatus that forms an applied film on one surface of a substrate, comprising:
a dripping unit that drips an energy beam-curing applied material onto the one surface of the substrate;
a rotating unit that rotates the substrate;
a curing processing unit that emits an energy beam onto the applied material to cure the applied material;
an emission regulating unit that regulates emission of the energy beam onto the applied material on an outer circumferential edge part of the one surface; and
a control unit,
wherein after controlling the dripping unit to drip the applied material onto the one surface and controlling the rotating unit to rotate the substrate and cause the applied material to spread out, the control unit controls the curing processing unit to emit the energy beam toward the one surface and controls the emission regulating unit to regulate the emission of the energy beam onto the applied material on the outer circumferential edge part while controlling the rotating unit to rotate the substrate at a predetermined rotational velocity.

2. An applied film forming apparatus according to claim 1, wherein the emission regulating unit includes a plurality of shielding members that in a connected state construct a plate-like body in which a circular opening with a slightly smaller diameter than a diameter of the substrate is formed, and a moving mechanism for moving and connecting the shielding members to construct the plate-like body,
wherein the control unit controls the movement mechanism to move and connect the shielding members to regulate the emission of the energy beam on the applied material on the outer circumferential edge part.

3. An applied film forming apparatus according to claim 2, wherein gaps between the respective shielding members in the connected state and the outer circumferential edge part are respectively in a range of 2 mm to 10 mm, inclusive.

4. An applied film forming apparatus according to claim 1, wherein a wall part is disposed close to a side surface of the substrate during spreading out and causes the applied material that protrudes outside the substrate to flow downward along the side surface of the substrate.

5. An applied film forming method which spreads out an energy beam-curing applied material on one surface of a substrate and emits an energy beam onto the spread-out applied material to cure the applied material and form an applied film on the one surface,
wherein after the applied material is spread out, the energy beam is emitted toward the one surface and emission of the energy beam onto the applied material on an outer circumferential edge part of the one surface is regulated in a state where the substrate is rotated at a predetermined rotational velocity.

6. An applied film forming method according to claim 5, wherein the emission of the energy beam onto the applied material on the outer circumferential edge part is regulated by connecting a plurality of shielding members that in a connected state construct a plate-like body in which a circular opening with a slightly smaller diameter than a diameter of the substrate is formed.

7. An applied film forming method according to claim 6, wherein the respective shielding members are connected so that gaps between the respective shielding members in the connected state and the outer circumferential edge part are respectively in a range of 2 mm to 10 mm, inclusive.

8. An applied film forming method according to claim 5, wherein a wall part is disposed close to a side surface of the substrate during spreading out and causes the applied material that protrudes outside the substrate to flow downward along the side surface of the substrate.
